(19) United States
(12) Patent Application Publication
(10) Pub. No.: US 2009/0222859 A1
(43) Pub. Date: Sep. 3, 2009

(54) METHOD, APPARATUS, AND COMPUTER PROGRAM PRODUCT FOR IMPLEMENTING AUTOMATIC UPDATE OF TIME SHIFT CONTENT

(76) Inventors: Eric Lawrence Barsness, Pine Island, MN (US); John Matthew Santosuosso, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/041,356

(22) Filed: Mar. 3, 2008

(51) Int. Cl. G06F 3/00

(52) U.S. Cl. 725/50

(57) ABSTRACT

A method, apparatus, and computer program product implement automatic update of time shift content. Time sensitive information recorded on a client recording device is automatically updated responsive to updated content becoming available. Updating time sensitive information is enabled by a remote broadcast signal. The remote broadcast signal includes an embedded signal indicating sensitive information content.

### FIELD OF THE INVENTION

The present invention relates generally to the data processing field, and more particularly, relates to a method, apparatus, and computer program product for implementing automatic update of time shift programming.

### DESCRIPTION OF THE RELATED ART

A problem caused by time-shift programming is that certain information, for example in news reports, can be out-of-date or duplicated by the time it is viewed.

With the advent of digital video recording devices, time-shifted program viewing has greatly increased the problem of viewing out-of-date information. This means that those using digital video recording devices often end up recording either duplicate information or simply information that is out of date.

This problem has existed since videocassette recorders were used to record programs and watch them later, but digital video recording devices have greatly increased the likelihood of this problem occurring. Many people have their digital video recording devices set up to record the 5:30 national news and the 6:00 or 10:00 local news each day. That way no matter how late they get home from work they can watch the news, and by recording the evening local news they can catch that whenever they are done watching other time-shifted programs.

A need exists for an effective mechanism to avoid recording either duplicate information or simply information that is out of date.

### SUMMARY OF THE INVENTION

Principal aspects of the present invention are to provide a method, apparatus, and computer program product for implementing automatic update of time shift programming. Other important aspects of the present invention are to provide such method, apparatus, and computer program product substantially without negative effect and that overcome many of the disadvantages of prior art arrangements.

In brief, a method, apparatus, and computer program product are provided for implementing automatic update of time shift programming. Time sensitive information recorded on a client recording device is automatically updated responsive to updated content becoming available. Updating time sensitive information is enabled by a remote broadcast signal. A remote broadcast signal includes an embedded signal indicating time sensitive information content.

In accordance with features of the invention, the client recording device overlays updated content on top of the original content of the time sensitive information. Alternatively, the client recording device inserts replacement content into the original content of the time sensitive information.

In accordance with features of the invention, the content provider identifies updated content being available and then sends updated content when the client recording device recorded the original content. Alternatively, the client recording device controls downloading updated content.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic diagram illustrating an exemplary digital recording system for implementing automatic update of time shift programming in accordance with the preferred embodiment;

FIGS. 2A, and 2B are exemplary displays illustrating automatically updating of stored time shift programming information in accordance with the preferred embodiment;

FIGS. 3, 4, 5, and 6 are flow charts illustrating exemplary steps for implementing automatic update of time shift programming in accordance with the preferred embodiment;

FIGS. 7, and 8 are exemplary records respectively illustrating tracking information stored on a client device and on a content provider for automatically updating of stored time shift programming information in accordance with the preferred embodiment;

FIG. 9 are exemplary records illustrating tracking information stored on a client device with metadata applied from a content provider in a predefined format for automatically updating of stored time shift programming information in accordance with the preferred embodiment;

FIG. 10 is an exemplary data format for replacement data applied from content provider for data replacement appropriately for insertion into original content on a client device for automatically updating of stored time shift programming information in accordance with the preferred embodiment;

FIGS. 11 and 12 are flow charts illustrating exemplary steps for implementing automatic update of time shift programming in accordance with the preferred embodiment; and

FIG. 13 is a block diagram illustrating a computer program product in accordance with the preferred embodiment.

### DETAILED DESCRIPTION OF THE PREFERRED EMBODIMENTS

In accordance with features of the invention, a time-shift program method is provided that solves the problem that certain information, especially in news reports, can be out-of-date or duplicated by the time it is viewed. Methods of the invention also enable the joining together of time sensitive information such that multiple pieces of information are joined together, from multiple recorded shows. A set of methods of the invention is provided to update time-sensitive data in recorded media on a client device, such as a digital video recorder (DVR).

In accordance with features of the invention, an embedded signal included in a remote broad cast signal indicates when specific parts of the program are time sensitive information. Using this signal the DVR is enabled to locate the specific places in the program to update the content of the recorded program responsive to updated content becoming available. In a news program including sports scores, whenever the score from an in-progress game are first shown a portion of the screen can be left open such that when the game was complete the final score could be placed alongside or under the in-progress score. This features does not affect anyone viewing the program live. Something similar advantageously is done for stock reports, and the long term weather forecast. The unaltered audio would still match up with the video, when the additional updated content is provided.

In accordance with features of the invention, in another method downloading the updated content is provided without modifying the original content. An icon can be placed on the display screen, for example, similar to what is used in DVDs to allow viewers to see behind the scenes material while watching the movie. The user would then need to explicitly select the icon in order to see the updated content. This also allows complete alternative segments, such as if the news station recorded an updated weather segment every hour and sent it out to those DVRs that had recorded the news.

In accordance with features of the invention, options are provided for how and when the content is updated. One options is to update the content only when someone starts to watch the recorded program. For example, if a person starts to watch the news the DVR would immediately go on-line to download any content updates. Another example would be for either push or pull downloads of content at specific periods, like hourly. Another example would be to use predictive technology to download content close to the time when the user typically watches the program so that it is as current as possible without incurring any waiting time for downloads. DVR owners are given the option to turn this capability on or off as desired.

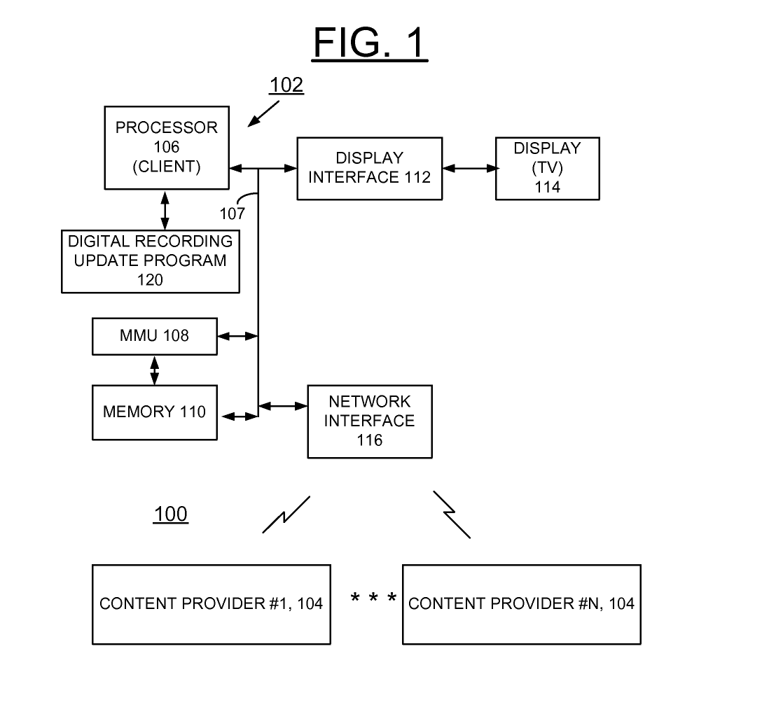

Having reference now to the drawings, in FIG. 1, there is shown a digital recording system generally designated by the reference character 100 for implementing automatic update of time shift programming in accordance with the preferred embodiment.

Digital recording system 100 includes a client device generally designated by the reference character 102 and a plurality of *content providers #1-N, 104. Client device 102 includes, for example, a digital video recorder (DVR) arranged in accordance with the preferred embodiment.

Client device 102 includes a processor 106 coupled by a system bus 107 to a memory management unit (MMU) 108 and a system memory 110. Client device 102 includes a display interface 112 coupled to the system bus 107 and connected to a display 114. Client device 102 includes a network interface 116 for connection, such as, broadband connections with the content providers #1-N, 104 of the preferred embodiment. Client device 102 includes a digital recording update program 120 of the preferred embodiment.

Digital recording system 100 together with the client device 102 is shown in simplified form sufficient for understanding the present invention. The illustrated client device 102 is not intended to imply architectural or functional limitations. The present invention can be used with various hardware implementations and systems and various other internal hardware devices, for example, multiple main processors.

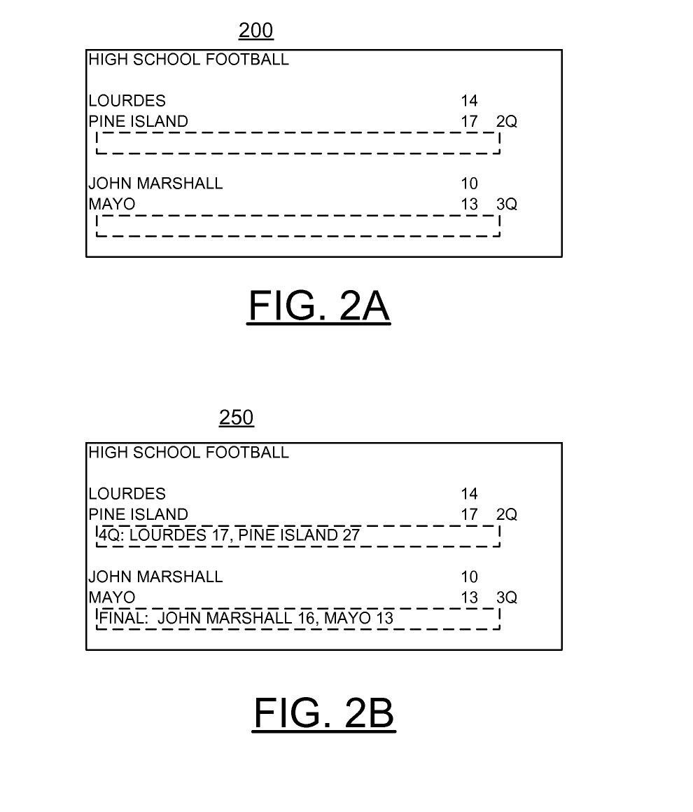

Referring now to FIGS. 2A, and 2B, there are shown exemplary displays respectively generally designated by the reference character 200, 250. The illustrated exemplary displays 200, 250 illustrate automatically updating of stored time shift programming information in accordance with the preferred embodiment.

Various kinds of information can be out of date in a matter of hours, such as stock market results, sports scores, weather reports and the like. Many times when watching the local news the sports sections show the results of completed games as well as changing scores of games still in progress. Weather reports can change greatly over a period of several hours, especially when there is severe weather in the area. During the news program the stock market report shows the current market conditions, which can vary by the second.

In FIG. 2A, exemplary display 200 shows high school football information providing team scores for incomplete games indicated as second quarter (2Q) and third quarter (3Q).

In FIG. 2B, exemplary display 250 shows the same high school football information providing team scores indicated as second quarter (2Q) and third quarter (3Q) together with updated information including team scores indicated as fourth quarter (4Q) and final. The client recording device overlays updated content on top of the original content display 200 of the time sensitive information to provide display 250. Alternatively, the client recording device inserts replacement content into the original content display 200 of the time sensitive information to provide display 250.

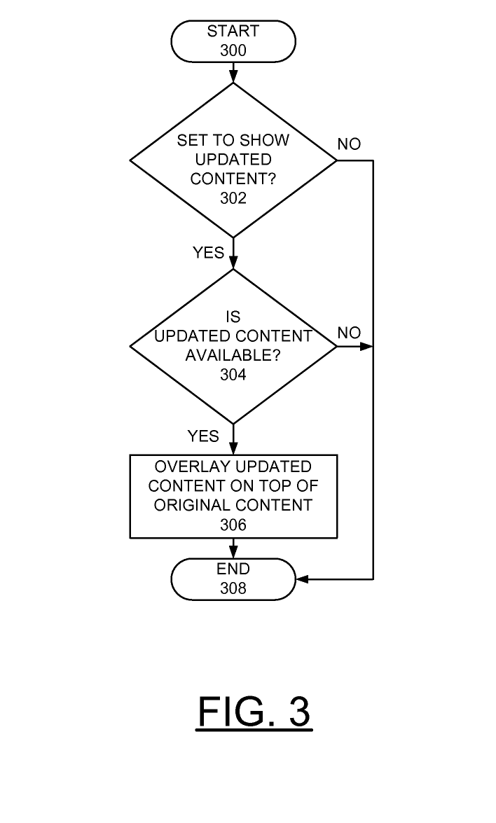

FIGS. 3, 4, 5, and 6 are flow charts illustrating exemplary steps for implementing automatic update of time shift programming in accordance with the preferred embodiment.

Referring now to FIG. 3, there are shown exemplary steps for implementing automatic update of time shift programming including content overlay in accordance with the preferred embodiment starting at a block 300. Checking whether the client device is set to show updated content is performed as indicated at a decision block 302. When the client device is set to show updated content, then checking for available updated content is performed as indicated at a decision block 304. When updated content is available, then the client device overlays the updated content on top of the original content as indicated at a block 306. This completes the operations as indicated at a block 308.

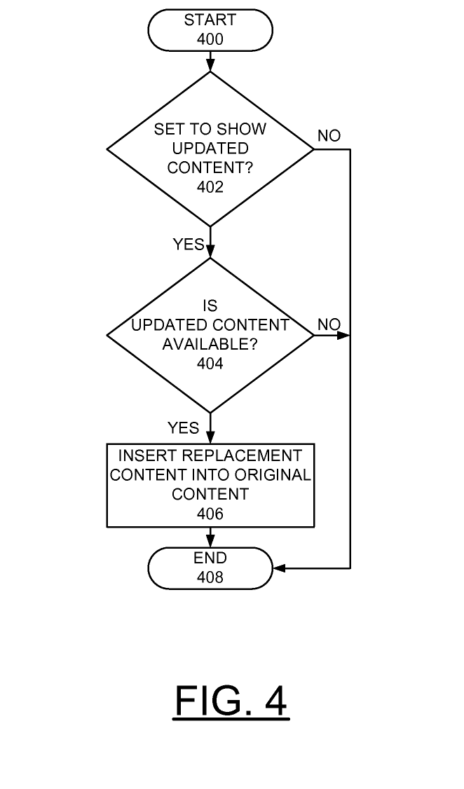

Referring now to FIG. 4, there are shown exemplary steps for implementing automatic update of time shift programming including content replacement in accordance with the preferred embodiment starting at a block 400. Checking whether the client device is set to show updated content is performed as indicated at a decision block 402. When the client device is set to show updated content, then checking for available updated content is performed as indicated at a decision block 404. When updated content is available, then the client device inserts the updated content or replacement content into the original content as indicated at a block 406. This completes the operations as indicated at a block 408.

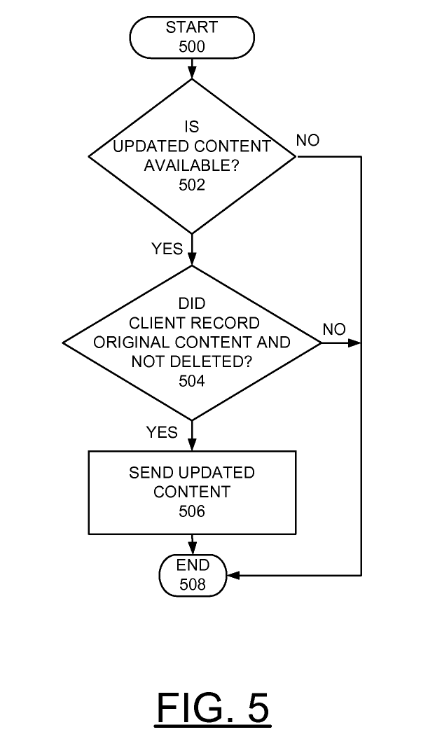

Referring now to FIG. 5, there are shown exemplary steps for implementing automatic update of time shift programming including a content provider pushing content in accordance with the preferred embodiment starting at a block 500. Checking for available updated content is performed as indicated at a decision block 502. When updated content is available, then checking whether the client device recorded the original content is performed and that the program has not been deleted as indicated at a decision block 504. When the client device recorded the original content that has not been deleted, then the content provider sends the updated content as indicated at a block 506. This completes the operations as indicated at a block 508.

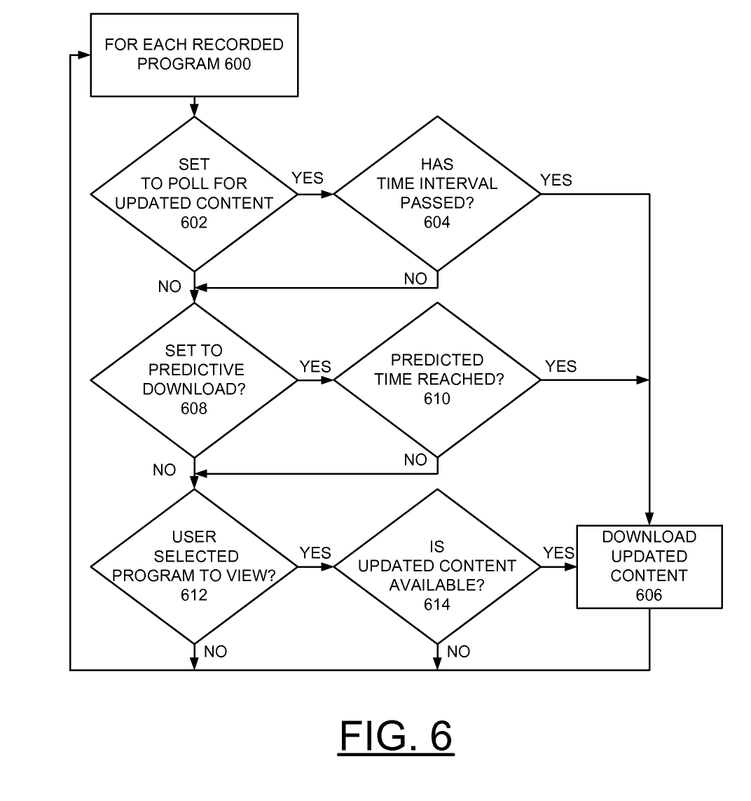

Referring now to FIG. 6, there are shown exemplary steps for implementing automatic update of time shift programming including a client device pulling content in accordance with the preferred embodiment starting for each recorded program at a block 600. Checking whether the client device is set to poll for updated content is performed as indicated at a decision block 602. When the client device is set to poll for updated content, then checking whether the time interval for polling has passed as indicated at a decision block 604. When the time interval for polling has passed, then the updated content is downloaded as indicated at a block 606.

Otherwise, when the client device is not set to poll for updated content at decision block 602, then checking whether the client device is set to predictive download as indicated at a block 608. When the client device is set to predictive download, checking whether the predicted time has been reached is performed as indicated at a decision block 610. When the predicted time has been reached, then the updated content is downloaded at block 606.

Otherwise, when the client device is not set to predictive download at decision block 608, then checking whether user selected a program to view is performed as indicated at a decision block 612. When user selected a program to view, then checking for available updated content is performed as indicated at a decision block 614. When updated content is available, then the updated content is downloaded at block 606. Then operations continue with a next recorded program at block 600.

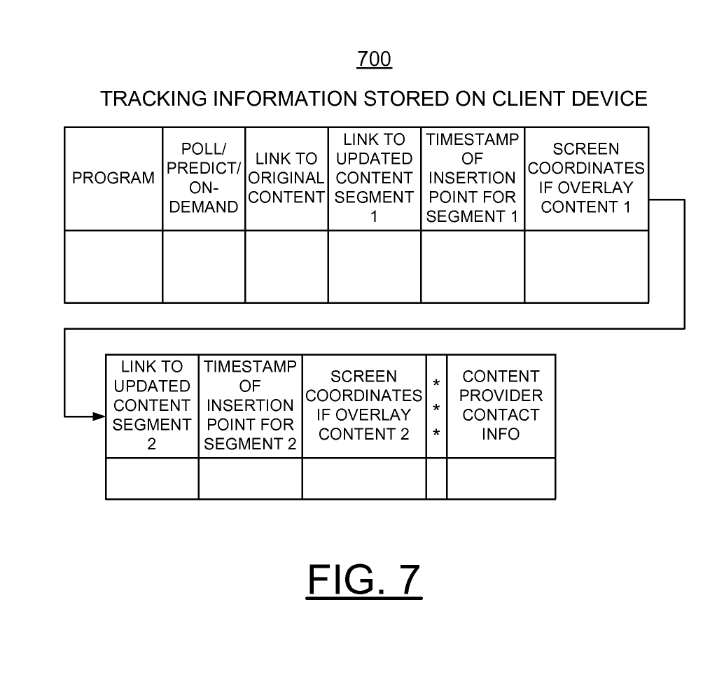

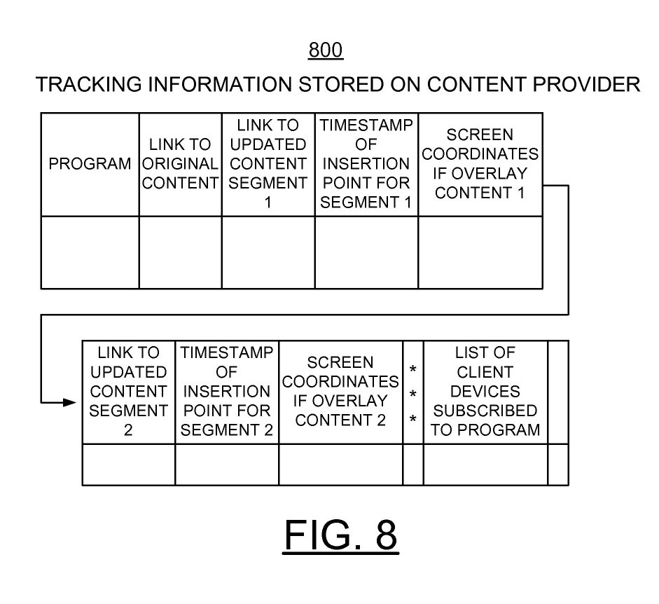

Referring to FIGS. 7, and 8, there are shown exemplary records respectively illustrating tracking information stored on a client device generally designated by the reference character 700 and on a content provider generally designated by the reference character 800 for automatically updating of stored time shift programming information in accordance with the preferred embodiment.

As shown in FIG. 7, tracking information 700 stored on the client device includes, for example, a program, poll, predict/on-demand settings, a link to updated content segment 1, a time stamp of insertion point for segment 1, screen coordinates if overlay content 1, link to updated content segment 2, a time stamp of insertion point for segment 2, and screen coordinates if overlay content 2.

As shown in FIG. 8, tracking information 800 stored on the content provider includes, for example, a program, a link to updated content segment 1, a time stamp of insertion point for segment 1, screen coordinates if overlay content 1, link to updated content segment 2, a time stamp of insertion point for segment 2, screen coordinates if overlay content 2, and a list of client devices subscribed to the program.

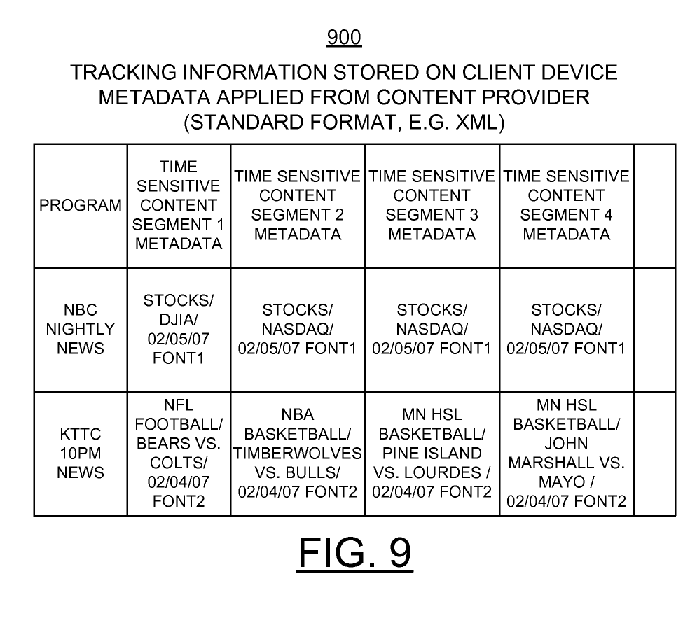

Referring to FIG. 9, there are shown exemplary tracking information stored on a client device with metadata applied from a content provider in a predefined format, such as XML, generally designated by the reference character 900 for automatically updating of stored time shift programming information in accordance with the preferred embodiment. Tracking information 900 stored on the client device includes for each program, time sensitive content segment 1 metadata, time sensitive content segment 2 metadata, time sensitive content segment 3 metadata, and time sensitive content segment 4 metadata,

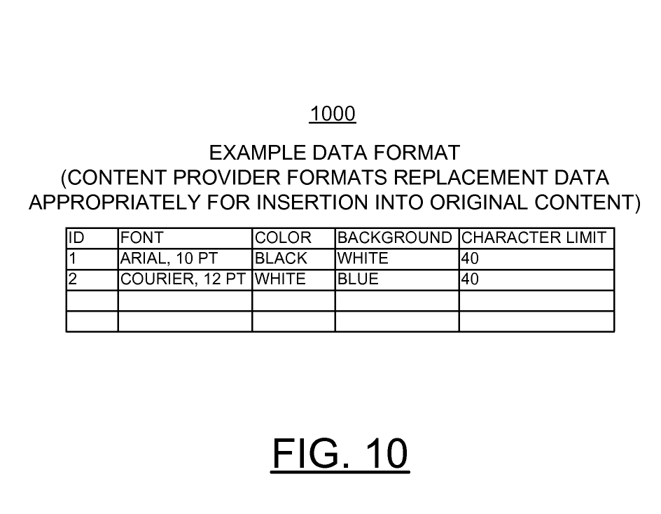

Referring to FIG. 10, there is shown an exemplary data format generally designated by the reference character 1000 for replacement data applied from content providers, including a third party content provider to format data replacement appropriately for insertion into original content on a client device for automatically updating of stored time shift programming information in accordance with the preferred embodiment. Data format for each segment identification ID includes a font, a font color, a background color, and a character limit.

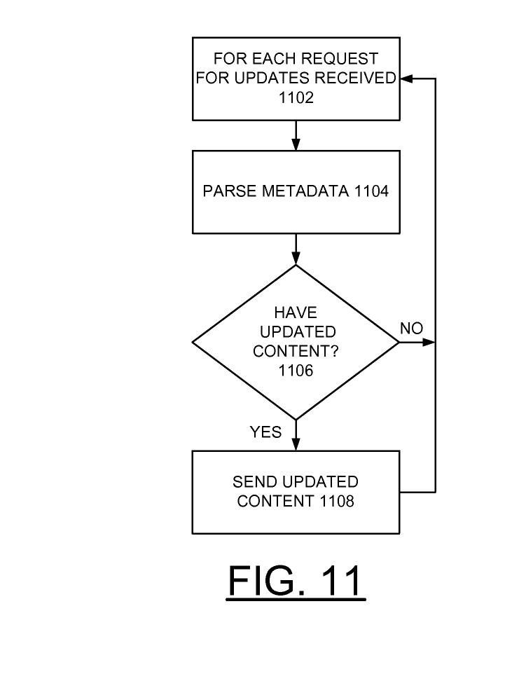

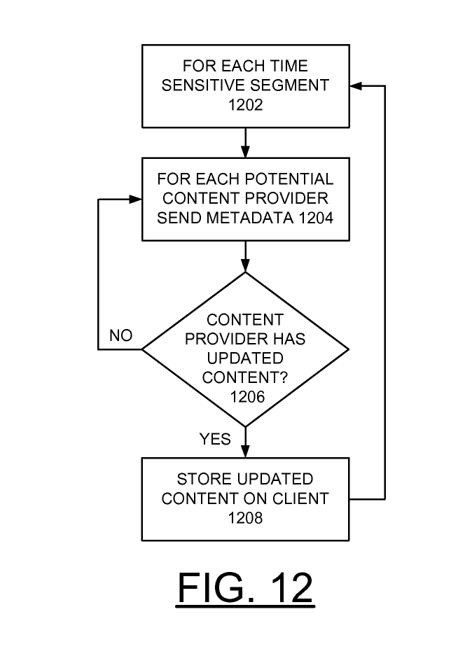

Referring to FIGS. 11 and 12, there are shown flow charts illustrating exemplary steps for implementing automatic update of time shift programming in accordance with the preferred embodiment.

In FIG. 11, exemplary steps of a content provider, either an original content provider or third party content provider, start for each request for updates received as indicated at a block 1102. As indicated at a block 1104, the content provider parses the metadata. Checking for updated content is performed as indicated at a decision block 1106. When updated content is identified at decision block 1106, then the updated content is sent as indicated at a block 1108. Then the operations continue for a next request for updates received at block 1102.

In FIG. 12, exemplary steps of a client device, start for each time sensitive segment as indicated at a block 1202, then as indicated at a block 1204, for each potential content provider, metadata is sent. Checking whether the content provider has updated content is performed as indicated at a decision block 1206. When updated content is identified at decision block 1206, then the updated content is stored on the client device as indicated at a block 1208. Then the operations continue for a time sensitive segment at block 1202.

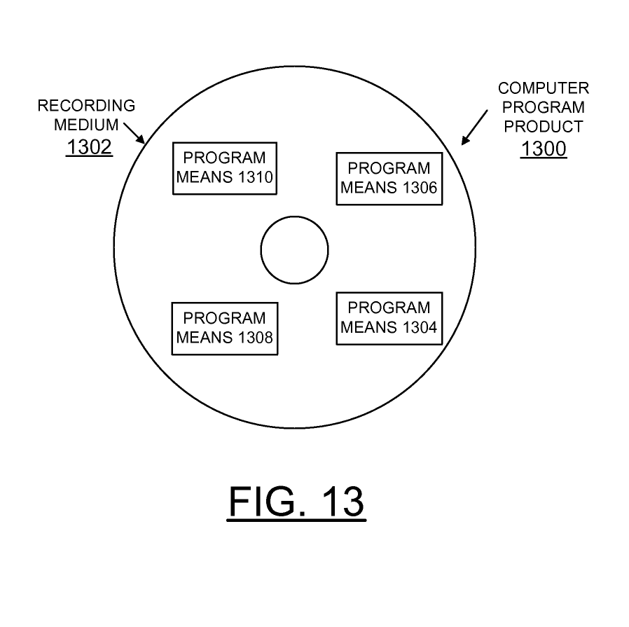

Referring now to FIG. 13, an article of manufacture or a computer program product 1300 of the invention is illustrated. The computer program product 1300 includes a recording medium 1302, such as, a floppy disk, a high capacity read only memory in the form of an optically read compact disk or CD-ROM, a tape, or another similar computer program product. Recording medium 1302 stores program means 1304, 1306, 1308, 1310 on the medium 1302 for carrying out the methods for implementing automatic updates of time shift programming of the preferred embodiment in the digital recording system 100 of FIG. 1.

A sequence of program instructions or a logical assembly of one or more interrelated modules defined by the recorded program means 1304, 1306, 1308, 1310, direct the digital recording system 100 for implementing automatic update of time shift programming of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing automatic update of time shift programming comprising:
providing an embedded signal indicating time sensitive information content in a remote broadcast signal;
enabling updating of time sensitive information on a client recording device; and
automatically updating time sensitive information recorded on the client recording device responsive to an updated content being available.

2. The method for implementing automatic update of time shift programming as recited in claim 1 wherein automatically updating time sensitive information recorded on the client recording device responsive to an updated content being available includes tracking information stored by a content provider.

3. The method for implementing automatic update of time shift programming as recited in claim 2 includes storing metadata by said content provider.

4. The method for implementing automatic update of time shift programming as recited in claim 1 wherein automatically updating time sensitive information recorded on the client recording device responsive to an updated content being available includes tracking information stored by the client recording device.

5. The method for implementing automatic update of time shift programming as recited in claim 4 includes storing metadata by the client recording device.

6. The method for implementing automatic update of time shift programming as recited in claim 5 wherein said content provider provides said metadata in a predefined format.

7. The method for implementing automatic update of time shift programming as recited in claim 1 wherein automatically updating time sensitive information recorded on the client recording device responsive to an updated content being available includes overlaying updated content on top of original content.

8. The method for implementing automatic update of time shift programming as recited in claim 1 wherein automatically updating time sensitive information recorded on the client recording device responsive to an updated content being available includes inserting replacement content into original content.

9. The method for implementing automatic update of time shift programming as recited in claim 1 wherein automatically updating time sensitive information recorded on the client recording device responsive to an updated content being available includes a content provider sending updated content to the client recording device.

10. The method for implementing automatic update of time shift programming as recited in claim 1 wherein automatically updating time sensitive information recorded on the client recording device responsive to an updated content being available includes the client recording device downloading updated content from a content provider.

11. The method for implementing automatic update of time shift programming as recited in claim 10 includes said content provider parsing metadata for each request for updated content received and sending updated content.

12. The method for implementing automatic update of time shift programming as recited in claim 10 includes the client recording device sending metadata to said content provider, and storing updated content on the client recording device.

13. A computer readable storage medium storing a computer program product for implementing automatic update of time shift programming in a recording system, said computer program product including instructions executed by the recording system to cause the recording system to perform the steps comprising:
providing an embedded signal indicating time sensitive information content in a remote broadcast signal;
enabling updating of time sensitive information on a client recording device; and
automatically updating time sensitive information recorded on the client recording device responsive to an updated content being available.

14. The computer readable storage medium storing a computer program product for implementing automatic update of time shift programming as recited in claim 13 includes storing metadata by the client recording device.

15. The computer readable storage medium storing a computer program product for implementing automatic update of time shift programming as recited in claim 14 includes providing said metadata in a predefined format by said content provider.

16. Apparatus for implementing automatic update of time shift programming comprising:
an embedded signal indicating time sensitive information content in a remote broadcast signal;
a client recording device,
said client recording device enabling updating of time sensitive information; and
said client recording device automatically updating time sensitive information recorded on the client recording device responsive to an updated content being available.

17. The apparatus for implementing automatic update of time shift programming as recited in claim 16 wherein said client recording device stores metadata for automatically updating time sensitive information recorded on the client recording device responsive to an updated content being available.

18. The apparatus for implementing automatic update of time shift programming as recited in claim 16 wherein a content provider provides said metadata in a predefined format.

19. The apparatus for implementing automatic update of time shift programming as recited in claim 16 includes said client recording device overlaying updated content on top of original content for automatically updating time sensitive information recorded on the client recording device responsive to an updated content being available.

20. The apparatus for implementing automatic update of time shift programming as recited in claim 16 includes said client recording device inserting replacement content into original content for automatically updating time sensitive information recorded on the client recording device responsive to an updated content being available.
